(19) United States
(12) Patent Application Publication
(10) Pub. No.: US 2014/0014876 A1
(43) Pub. Date: Jan. 16, 2014

(54) ACTIVATED CARBON ARTICLES AND COMPOSITIONS AND PROCESS FOR PRODUCING THE SAME

(71) Applicant: MILLIKEN & COMPANY, Spartanburg, SC (US)

(72) Inventors: Shulong Li, Spartanburg, SC (US); Christopher A. DeSoiza, Greer, SC (US)

(21) Appl. No.: 13/930,678

(22) Filed: Jun. 28, 2013

Related U.S. Application Data
(60) Provisional application No. 61/669,907, filed on Jul. 10, 2012.

(51) Int. Cl. B01J 20/28; B01J 20/32

(52) U.S. Cl. CPC B01J 20/28016; B01J 20/3293; B01J 20/28064
USPC 252/184; 427/214; 427/220

(57) ABSTRACT

An article comprises an activated carbon core, a hydrophobic agent, and a mercury oxidation facilitation agent. A composition comprises a plurality of activated carbon particles, a hydrophobic agent, and a mercury oxidation facilitation agent. A process for producing treated activated carbon particles comprises the steps of providing activated carbon particles, providing a hydrophobic agent, providing a mercury oxidation facilitation agent, and applying the hydrophobic agent and the mercury oxidation facilitation agent to at least a portion of the activated carbon particles.

### CROSS-REFERENCE TO RELATED APPLICATIONS

This application claims, pursuant to 35 U.S.C. §119(e), the benefit of the filing date of U.S. patent application Ser. No. 61/669,907, which was filed on Jul. 10, 2012.

### TECHNICAL FIELD OF THE INVENTION

This application relates to activated carbon articles and compositions comprising the same. The articles and compositions described herein are believed to be suitable for use as chemical adsorbents in industrial processes. The application also relates to a process for producing activated carbon particles and compositions comprising such particles.

### BACKGROUND

It is well-known that activated carbon is particularly effective as a chemical adsorbent. Given this property, activated carbon is used as an adsorbent in a variety of industrial processes. For example, the EPA and various other entities have studied and advocated the use of activated carbon in the treatment of flue gases produced during the combustion of coal, such as the flue gases produced at coal fired power plants. This process, which is known as “activated carbon injection,” has been touted as a potentially effective means for reducing the mercury emissions that typically accompany the combustion of coal.

Despite the touted benefits of activated carbon injection, the efficacy of the process is believed to be limited by some of the inherent characteristics of the activated carbon. For example, it is believed that the porous nature of the activated carbon, which is the very property that makes the activated carbon useful in the process, allows the product to absorb large amounts of the water vapor and/or unwanted condensation present in both the ambient atmosphere (such as water vapor absorbed during storage of the activated carbon) and the flue gas environment. Once this water vapor and/or unwanted condensation has been absorbed, the effective pore volume of the activated carbon (that is, the pore volume that is available for adsorption of mercury) can be dramatically reduced. And this reduction in effective pore volume means that each kilogram of activated carbon used in the process is less effective than it would otherwise be if the activated carbon had not absorbed the water vapor. This reduction in efficacy means the process is overall less efficient.

A need therefore remains for activated carbon articles (e.g., particles) and compositions that can address some of the deficiencies of known activated carbon particles and/or compositions presently used in industrial processes, such as activated carbon injection processes. A need also remains for a process for producing such activated carbon articles (e.g., particles) and compositions. The embodiments of the articles, compositions, and processes disclosed herein attempt to address these needs.

### BRIEF SUMMARY OF THE INVENTION

In several embodiments, the invention generally provides activated carbon articles, compositions comprising activated carbon particles, a process for producing such particles, and a process for producing such compositions. These activated carbon articles (e.g., particles) and compositions are believed to be suitable for use as chemical adsorbents and mercury sequestration agents in a variety of industrial processes, such as the activated carbon injection process used in coal-fired power plants.

In a first embodiment, the invention provides an article comprising:

(a) an activated carbon core, the activated carbon core having an outer surface;

(b) a hydrophobic agent selected from the group consisting of film-forming fluorocarbon polymers, silicones, alkylsilanes, waxes, and mixtures thereof, at least a portion of the hydrophobic agent being disposed on at least a portion of the outer surface of the activated carbon core; and

(c) a mercury oxidation facilitation agent.

In a second embodiment, the invention provides a composition comprising:

(a) a plurality of activated carbon particles, the activated carbon particles having an outer surface;

(b) a hydrophobic agent selected from the group consisting of film-forming fluorocarbon polymers, silicones, alkylsilanes, waxes, and mixtures thereof, at least a portion of the hydrophobic agent being disposed on at least a portion of the outer surface of at least a portion of the activated carbon particles; and

(c) a mercury oxidation facilitation agent.

In a third embodiment, the invention provides a process for producing treated activated carbon particles comprising the steps of:

(a) providing a plurality of activated carbon particles, the activated carbon particles having an outer surface;

(b) providing a hydrophobic agent selected from the group consisting of film-forming fluorocarbon polymers, silicones, alkylsilanes, waxes, and mixtures thereof;

(c) providing a mercury oxidation facilitation agent;

(d) applying the hydrophobic agent to at least a portion of the outer surface of at least a portion of the activated carbon particles; and

(e) applying the mercury oxidation facilitation agent to at least a portion of the outer surface of at least a portion of the activated carbon particles.

In a fourth embodiment, the invention provides a process for producing treated activated carbon particles comprising the steps of:

(a) providing a plurality of activated carbon particles, the activated carbon particles having an outer surface;

(b) providing a hydrophobic agent selected from the group consisting of film-forming fluorocarbon polymers, silicones, alkylsilanes, waxes, and mixtures thereof;

(c) providing a mercury oxidation facilitation agent;

(d) applying the mercury oxidation facilitation agent to at least a portion of the outer surface of at least a portion of the activated carbon particles; and

(e) applying the hydrophobic agent to at least a portion of the outer surface of at least a portion of the activated carbon particles.

In a fifth embodiment, the invention provides a process for producing treated activated carbon particles comprising the steps of:

(a) providing a plurality of activated carbon particles, the activated carbon particles having an outer surface;

(b) providing a treatment composition comprising:
(i) a hydrophobic agent selected from the group consisting of film-forming fluorocarbon polymers, silicones, alkylsilanes, waxes, and mixtures thereof; and
(ii) a mercury oxidation facilitation agent; and

(c) applying the treatment composition to at least a portion of the outer surface of at least a portion of the activated carbon particles.

### DETAILED DESCRIPTION OF THE INVENTION

In a first embodiment, the invention provides an article comprising an activated carbon core. As utilized herein, the term “activated carbon” is used to refer to an amorphous form of carbon that has been produced and/or processed so that it possesses a highly porous structure and correspondingly high surface area. For example, in a preferred embodiment, the activated carbon has a BET surface area of about 500 m²/g or more, about 750 m²/g or more, about 1,000 m²/g or more, about 1,250 m²/g or more, or about 1,500 m²/g or more.

The activated carbon core can be provided in any suitable form. For example, the activated carbon core can be a powder, a fine granule (e.g., a granule having an average diameter of about 0.15 mm to about 0.25 mm), a granule (e.g., a granule having an average diameter of about 0.3 mm to about 0.85 mm), a fiber, a fabric, a nonwoven felt, a porous honeycomb structure, an extruded particle, or a bead. The activated carbon core can be of any suitable size. In a preferred embodiment, the activated carbon core is a powdered activated carbon having a particle size (e.g., an average particle size) of about 1 μm to about 500 μm, about 10 μm to about 100 μm, or about 10 μm to about 50 μm.

The article further comprises a hydrophobic agent. The hydrophobic agent is included in the article in order to impart a desired degree of hydrophobicity to the activated carbon. By rendering the activated carbon hydrophobic, the activated carbon absorbs less water vapor and/or condensation and, therefore, the pore volume of the activated carbon that is available for adsorption of mercury is retained and/or maximized. Furthermore, rendering activated carbon particles hydrophobic can improve the flow characteristics of the particles because activated carbon particles that have absorbed moisture are more susceptible to agglomeration. Preferably, at least a portion of the hydrophobic agent is disposed on at least a portion the outer surface of the activated carbon core. The hydrophobic agent can be any suitable agent that renders the activated carbon core more hydrophobic than the virgin (i.e., untreated) activated carbon. In a preferred embodiment, the hydrophobic agent is selected from the group consisting of fluorocarbon polymers, silicones, alkylsilanes, waxes, and mixtures thereof. The fluorocarbon polymers suitable for use as the hydrophobic agent can be any suitable fluorocarbon polymer (e.g., a film-forming fluorocarbon homopolymer or copolymer) that is capable of forming a film or coating on the surface of the activated carbon core. In a preferred embodiment, the hydrophobic agent is a film-forming fluorocarbon polymer comprising repeating units derived from a monomer selected from the group consisting of fluorinated acrylate monomers, fluorinated acrylamide monomers, fluorinated ethylenic monomers, fluorinated polyols, fluorinated polyisocyanates, and mixtures thereof. Suitable fluorocarbon polymers can also comprise repeating units derived from other fluorine containing or non-fluorinated comonomers, such as methacrylates, acrylates, vinyl chloride, vinylidene chloride, vinyl fluoride, vinylidene fluoride, (meth)acrylic acid, (meth)acrylamide, acrylonitrile, silicone acrylate, and the like. Suitable fluorocarbon polymers can also be a product obtained from reacting a fluorocarbon polymer with a silicone, an isocyanate, an epoxy, a formaldehyde-amino resin or other organic compounds. The silicones suitable for use as the hydrophobic agent can be any suitable silicone compound. Suitable silicone compounds include, but are not limited to, polydimethylsiloxanes, polyhydromethylsiloxanes, amino-silicones, polymethylphenylsiloxanes, siloxane copolymers, and mixtures thereof. Suitable siloxane copolymers include, but are not limited to, copolymers comprising two or more monomer units selected from the group consisting of dimethylsiloxane, methylhydrosiloxane, methylphenylsiloxane, diphenylsiloxane, amino-substituted siloxane, and epoxide-substituted siloxane. The alkylsilanes suitable for use as the hydrophobic agent can be any suitable alkylsilane compound. Suitable alkylsilanes include, but are not limited to, those compounds conforming to the formula R₁Si(OR₂)₃, where R₁ is an alkyl group or a fluoroalkyl group containing 4 or more carbon atoms and R₂ is selected from the group consisting of methyl, ethyl, isopropyl, and butyl. Suitable examples of R₁ include, but are not limited to, tert-butyl, octyl, lauryl, hexyl, pentyl, heptyl, and perfluorinated alkyl groups comprising 4 or more carbon atoms. The waxes suitable for use as the hydrophobic agent can be any suitable wax, including natural waxes, synthetic waxes, and mixtures thereof. Suitable natural waxes include, but are not limited to esters of fatty acids, esters of long chain alcohols, and mixtures thereof. Suitable synthetic waxes include, but are not limited to, hydrocarbon waxes (e.g., paraffin), polyolefin waxes (e.g., polyethylene wax), alkylated melamines, and mixtures thereof.

The hydrophobic agent can be present in the article in any suitable amount. The desired amount of the hydrophobic agent may depend upon several factors, such as the type of hydrophobic agent, the hydrophobicity of the hydrophobic agent, and the desired degree of hydrophobicity to be imparted to the activated carbon and article. In a preferred embodiment, the hydrophobic agent can be present in an amount of about 0.1% or more, about 0.2% or more, about 0.3% or more, about 0.4% or more, or about 0.5% or more based on the weight of the activated carbon core. In a preferred embodiment, the hydrophobic agent can be present in an amount of about 10% or less, about 9% or less, about 8% or less, about 7% or less, about 6% or less, about 5% or less, about 4% or less, about 3% or less, or about 2.5% or less based on the weight of the activated carbon core. In certain preferred embodiments, the hydrophobic agent can be present in an amount of about 0.1% to about 5% (e.g., about 0.1% to about 2.5%), about 0.2% to about 5% (e.g., about 0.2% to about 2.5%), about 0.3% to about 5%, or about 0.3% to about 2.5% based on the weight of the activated carbon core.

The article further comprises a mercury oxidation facilitation agent. The mercury oxidation facilitation agent is present in the article in order to effect or promote the oxidation of elemental mercury contained in the flue gases. Generally, it is believed that oxidized mercury is more easily sequestered that elemental mercury. Preferably, at least a portion of the mercury oxidation facilitation agent is disposed on at least a portion of the outer surface of the activated carbon core. As utilized herein, the term “mercury oxidation facilitation agent” refers to an agent that (1) is capable of oxidizing elemental mercury contained in fossil fuel (e.g., coal) combustion gases at a temperature of from about 120° C. (250° F.) to about 230° C. (450° F.) or (2) interacts with other species present in fossil fuel (e.g., coal) combustion gases at a temperature of from about 120° C. (250° F.) to about 230° C. (450° F.) to result in the oxidation of elemental mercury contained in the combustion gases. Thus, suitable mercury oxidation facilitation agents include those compounds that can themselves oxidize the elemental mercury (i.e., the agent or a component in the agent has a reduction potential greater than the reduction potential of elemental mercury in the combustion gas environment). Suitable mercury oxidation facilitation agents also include those compounds that themselves are incapable of oxidizing elemental mercury (that is, neither the agent nor a component in the agent has a reduction potential greater than the reduction potential of elemental mercury in the combustion gas environment) but are known to interact with other species present in the combustion gases to result in the oxidation of elemental mercury (oftentimes by mechanisms that are not well understood due to the complexities of the combustion gas environment). Further, these different types of mercury oxidation facilitation agents can be used together in any suitable combination.

In a preferred embodiment, the mercury oxidation facilitation agent is selected from the group consisting of bromide salts, chloride salts, iodide salts, permanganate salts, perchlorate salts, perbromate salts, hypochlorite salts, copper(II) salts, iron(III) salts, cerium (IV) oxide, copper(II) oxide, iron(III) oxide, manganese(IV) oxide, vanadium(V) oxide, elemental halogen species (e.g., bromine and iodine), and mixtures thereof. In a more specific preferred embodiment, the mercury oxidation facilitation agent preferably is selected from the group consisting of copper(II) salts, with copper(II) chloride, copper(II) bromide, copper(II) sulfide, copper zeolites (zeolites with copper(II) ions as counterions), and mixtures thereof being particularly preferred. In another preferred embodiment, the mercury oxidation facilitation agent is selected from the group consisting of ammonium bromide, magnesium bromide, sodium bromide, elemental halogen species, and mixtures thereof. In another preferred embodiment, the mercury oxidation facilitation agent is selected from the group consisting of chlorinated aliphatic compounds, brominated aliphatic compounds, and mixtures thereof. These different types of mercury oxidation facilitation agents can be used alone or in any suitable combination. For example, one or more of a bromide salt, chloride salt, iodide salt, permanganate salt, perchlorate salt, perbromate salt, hypochlorite salt, copper(II) salt, iron(III) salt, cerium (IV) oxide, copper(II) oxide, iron(III) oxide, manganese(IV) oxide, elemental halogen species, and vanadium(V) oxide can be used in combination with one or more of a chlorinated aliphatic compound or brominated aliphatic compound.

The mercury oxidation facilitation agent can be present in any suitable amount. The suitable amount of the mercury oxidation facilitation agent may depend upon several factors, such as the type of mercury oxidation facilitation agent used, the activity of the particular mercury oxidation facilitation agent used, and the amount of elemental mercury to be oxidized. In a preferred embodiment, the mercury oxidation facilitation agent is present in an amount of about 0.1% or more, about 0.5% or more, 1% or more, about 1.5% or more, or about 2% or more based on the weight of the activated carbon core. In a preferred embodiment, the mercury oxidation facilitation agent is present in an amount of about 20% or less, about 15% or less, about 10% or less, about 9% or less, about 8% or less, about 7% or less, about 6% or less, or about 5% or less based on the weight of the activated carbon core. In certain preferred embodiments, the mercury oxidation facilitation agent is present in an amount of about 0.1% to about 20%, about 0.5% to about 15%, about 1% to about 10%, or about 1.5% to about 10% (e.g., about 1.5% to about 5%) based on the weight of the activated carbon core. In another preferred embodiment, the mercury oxidation facilitation agent can be present in a higher amount relative to the weight of the activated carbon core, such as about 5% or more, about 10% or more, about 20% or more, about 30% or more, about 40% or more, or about 50% or more based on the weight of the activated carbon core. In such embodiments, the mercury oxidation facilitation agent preferably is present in an amount of about 500% or less, about 200% or less, or about 100% or less based on the weight of the activated carbon core. Thus, in certain possibly preferred embodiments, the mercury oxidation facilitation agent can be present in an amount of about 5% to about 500% (about 5% to about 200%, about 5% to about 100%, or about 5% to about 20%), about 10% to about 500% (e.g., about 10% to about 200% or about 10% to about 100%), about 20% to about 500% (e.g., about 20% to about 200%), or about 30% to about 500% based on the weight of activated carbon core.

In a second embodiment, the invention provides a composition comprising a plurality of activated carbon particles, a hydrophobic agent, and a mercury oxidation facilitation agent. The activated carbon particles in the composition can be any suitable activated carbon particles. Suitable activated carbon particles include, but are not limited to, the activated carbon particles described above as suitable for use as the activated carbon core of the first embodiment.

As noted above, the composition of the invention also comprises a hydrophobic agent and a mercury oxidation facilitation agent. The hydrophobic agent and mercury oxidation facilitation agent in the composition can be any suitable hydrophobic agent and mercury oxidation facilitation agent, including the hydrophobic agents and mercury oxidation facilitation agents described above as suitable for use in the first embodiment. The hydrophobic agent and mercury oxidation facilitation agent can be present in the composition in any suitable amount, including any suitable combination of the amounts described above in connection with the first embodiment. As will be understood, in connection with the composition, the amounts of the hydrophobic agent and the mercury oxidation facilitation agent described above will be based on the weight of the activated carbon particles present in the composition.

In another series of embodiments, the invention provides a process for producing treated activated carbon particles, such as the treated activated carbon particles described above in connection with the first and second embodiments. In general, the process entails providing a plurality of activated carbon particles, providing a hydrophobic agent, providing a mercury oxidation facilitation agent, and applying the hydrophobic agent and the mercury oxidation facilitation agent to at least a portion of the activated carbon particles. Within this general framework, the process can be adapted with regard to the order and/or manner in which the hydrophobic agent and mercury oxidation facilitation agent are applied to the activated carbon particles.

In a first embodiment of the process generally described above, the process comprises the steps of (a) providing a plurality of activated carbon particles (b) providing a hydrophobic agent, (c) providing a mercury oxidation facilitation agent, (d) applying the hydrophobic agent to at least a portion of the outer surface of at least a portion of the activated carbon particles, and (e) applying the mercury oxidation facilitation agent to at least a portion of the outer surface of at least a portion of the activated carbon particles.

In a second embodiment of the process generally described above, the process comprises the steps of (a) providing a plurality of activated carbon particles (b) providing a hydrophobic agent, (c) providing a mercury oxidation facilitation agent, (d) applying the mercury oxidation facilitation agent to at least a portion of the outer surface of at least a portion of the activated carbon particles, and (e) applying the hydrophobic agent to at least a portion of the outer surface of at least a portion of the activated carbon particles.

In a third embodiment of the process generally described above, the process comprises the steps of (a) providing a plurality of activated carbon particles, (b) providing a treatment composition, and (c) applying the treatment composition to at least a portion of the outer surface of at least a portion of the activated carbon particles. The treatment composition comprises (i) a hydrophobic agent and (ii) a mercury oxidation facilitation agent.

In each embodiment of the process described above, the activated carbon particles can be any suitable activated carbon particles, including any of the activated carbon particles described above in connection with the first and second embodiments. Also, the hydrophobic agent and the mercury oxidation facilitation agent can be any suitable hydrophobic agent and mercury oxidation facilitation agent, including those described above in connection with the first and second embodiments. Further, the hydrophobic agent and the mercury oxidation facilitation agent can be used in any suitable amounts, including those amounts described above in connection with the first and second embodiments.

The hydrophobic agent, the mercury oxidation facilitation agent, and the treatment composition can be applied to the activated carbon particles using any suitable technique. In order to facilitate application of these agents or the treatment composition, the hydrophobic agent, the mercury oxidation facilitation agent, and the treatment composition are typically provided in a liquid form. Utilizing a liquid form can facilitate handling of the agent and/or the composition and permits the agent and/or composition to be applied to the activated carbon particles by several techniques. For example, the hydrophobic agent, the mercury oxidation facilitation agent, and/or the treatment composition can be applied to the activated carbon particles by immersing at least a portion of the activated carbon particles in the agent and/or the composition. Alternatively, the hydrophobic agent, the mercury oxidation facilitation agent, and/or the treatment composition can be applied by spraying the agent and/or the composition onto the activated carbon particles. In such an application process, the agent and/or the treatment composition can be sprayed in the form of a simple liquid stream or the agent and/or the treatment composition can be sprayed in an atomized or aerosol form. Further, in such an application process, the activated carbon particles can be conveyed to the spray by any suitable means. For example, the activated carbon particles can be conveyed to the spray in a fluidized state, such as that produced by a fluidized bed. The activated carbon particles can also be placed into a drum which is rotated as the particles are sprayed. The fluidization and/or movement of the activated carbon particles produced by each of these techniques helps to more evenly apply the agent and/or the composition to the activated carbon particles.

Preferably, the agent and/or the treatment composition is applied in the form of a spray or aerosol of fine mist, which conditions are believed to provide a more uniform treatment of the activated carbon particles. The appropriate particle size of the spray or mist is believed to depend, at least in part, on the size of the activated carbon particles to be treated. Preferably, the particle size of the spray or mist is no larger than about 2 to about 5 times the size of the activated carbon particles to be treated. Thus, for an activated carbon particle having an average size of about 10 μm to about 50 μm, the average particle size of the spray or mist preferably is about 5 μm to about 200 μm or about 20 μm to about 100 μm.

It is believed that the activated carbon particles described above and the particles produced by the above-described process possess additional advantages beyond improved performance as a chemical adsorbent in industrial processes. The fly ash produced by the combustion of coal can be used as a filler or binder for concrete mixtures. However, it is generally known that untreated activated carbon can absorb some of the additives used in concrete mixtures, such as the air entrainment additive(s), which will negatively impact the desired properties of the concrete (e.g., negatively impact the freeze-thaw stability of the concrete). These deleterious effects have limited the use of activated carbon injection in those processes where the fly ash is intended to be sold for use in concrete. But it is believed that the activated carbon particles described above will absorb less of the additives (e.g., air entrainment additives) in the concrete mixture, thereby minimizing the negative effects normally associated with the use of activated carbon-containing fly ash. Thus, it is believed that the activated carbon particles described above will enable the wider use of activated carbon injection in conjunction with those processes where the resulting fly ash is intended to be sold for use in concrete.

The following examples further illustrate the subject matter described above but, of course, should not be construed as in any way limiting the scope thereof.

### EXAMPLE 1

This example demonstrates the production of activated carbon particles and a composition according to the invention.

Approximately fifty grams (50 g) of a powdered activated carbon suitable for use in an activated carbon injection process is dried at a temperature of approximately 150° C. for several hours and allowed to cool in a glass desiccator. The activated carbon is then sprayed with approximately two grams (2 g) of a 50% solution of Unidyne TG 5601, which is available from Daikin Industries, Ltd. and is believed to be a silicone modified C6 fluorocarbon repellent dispersion. The solution is sprayed by hand onto the activated carbon in an atomized form, and the activated carbon is manually mixed after each stroke of spray to ensure more even coverage of the particles with the fluorocarbon repellent. Following application of the fluorocarbon repellent, the powdered activated carbon is then mechanically mixed with powdered ammonium bromide in an amount of approximately 2-3% by weight based on the weight of the powdered activated carbon.

### EXAMPLE 2

This example demonstrates the production of activated carbon particles and a composition according to the invention.

Approximately fifty grams (50 g) of a powdered activated carbon suitable for use in an activated carbon injection process is dried at a temperature of approximately 150° C. for several hours and allowed to cool in a glass desiccator. The activated carbon is then sprayed with a treatment composition made by combining a 50% solution of Unidyne TG 5601 and a 40% aqueous solution of sodium bromide in a weight ratio of approximately 1:2. The resulting treatment composition is sprayed by hand onto the activated carbon in an atomized form, and the activated carbon is manually mixed after each stroke of spray to ensure more even coverage of the particles with the treatment composition. The treatment composition is applied to the powdered activated carbon in an amount sufficient to achieve a sodium bromide add-on of approximately 2-3% by weight based on the weight of the powdered activated carbon.

### EXAMPLE 3

This example demonstrates the production of activated carbon particles and a composition according to the invention.

Approximately fifty grams (50 g) of a powdered activated carbon suitable for use in an activated carbon injection process is dried at a temperature of approximately 150° C. for several hours and allowed to cool in a glass desiccator. The activated carbon is then sprayed with a 40% aqueous solution of sodium bromide. The solution is sprayed by hand onto the activated carbon in an atomized form, and the activated carbon is manually mixed after each stroke of spray to ensure more even coverage of the particles with the sodium bromide solution. The solution is applied to the powdered activated carbon in an amount sufficient to achieve a sodium bromide add-on of approximately 2-3% by weight based on the weight of the powdered activated carbon. Following application of the sodium bromide solution, the activated carbon is then sprayed with approximately two grams (2 g) of a 50% solution of Unidyne TG 5601. The solution is sprayed by hand onto the activated carbon in an atomized form, and the activated carbon is manually mixed after each stroke of spray to ensure more even coverage of the particles with the fluorocarbon repellent.

### EXAMPLE 4

This example demonstrates the production of activated carbon particles and a composition according to the invention.

The procedure of Example 1 described above is repeated, expect that the Unidyne TG-5601 solution is replaced with a mixture containing 40% Unidyne TG-5601, 10% Dow Corning®IE-6694 water repellent emulsion, and 50% water. The Dow Corning®IE-6694 water repellent emulsion is available from Dow Corning and is believed to be a mixed emulsion of a silicone and alkylsilane, more specifically a mixed emulsion of approximately 10-30% n-octyltriethoxysilane and approximately 1-5% aminofunctional silane.

### EXAMPLE 5

This example demonstrates the production of activated carbon particles and a composition according to the invention.

The procedure of Example 1 described above is repeated, except that approximately 2 grams (2 g) of a 50% solution of Dow Corning®IE-6694 water repellent emulsion is used in place of the Unidyne TG-5601 solution.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. An article comprising:
(a) an activated carbon core, the activated carbon core having an outer surface;
(b) a hydrophobic agent selected from the group consisting of film-forming fluorocarbon polymers, silicones, alkylsilanes, waxes, and mixtures thereof, at least a portion of the hydrophobic agent being disposed on at least a portion of the outer surface of the activated carbon core; and
(c) a mercury oxidation facilitation agent.

2. The article of claim 1, wherein the activated carbon core has a BET surface area of about 500 m²/g or more.

3. The article of claim 1, wherein the hydrophobic agent is a film-forming fluorocarbon polymer comprising repeating units derived from a monomer selected from the group consisting of fluorinated acrylate monomers, fluorinated acrylamide monomers, fluorinated ethylenic monomers, fluorinated polyols, fluorinated polyisocyanates, and mixtures thereof.

4. The article of claim 1, wherein the hydrophobic agent is present in an amount of about 0.1% to about 5% based on the weight of the activated carbon core.

5. The article of claim 1, wherein at least a portion of the mercury oxidation facilitation agent is disposed on at least a portion of the outer surface of the activated carbon core.

6. The article of claim 1, wherein the mercury oxidation facilitation agent is selected from the group consisting of bromide salts, chloride salts, iodide salts, permanganate salts, perchlorate salts, perbromate salts, hypochlorite salts, copper(II) salts, iron(III) salts, cerium (IV) oxide, copper(II) oxide, iron(III) oxide, manganese(IV) oxide, vanadium(V) oxide, elemental halogen species, and mixtures thereof.

7. The article of claim 1, wherein the mercury oxidation facilitation agent is selected from the group consisting of copper(II) salts.

8. The article of claim 7, wherein the mercury oxidation facilitation agent is selected from the group consisting of copper(II) chloride, copper(II) bromide, and mixtures thereof.

9. The article of claim 1, wherein the mercury oxidation facilitation agent is selected from the group consisting of ammonium bromide, magnesium bromide, sodium bromide, elemental halogen species, and mixtures thereof.

10. The article of claim 1, wherein the mercury oxidation facilitation agent is selected from the group consisting of chlorinated aliphatic compounds, brominated aliphatic compounds, and mixtures thereof.

11. The article of claim 1, wherein the mercury oxidation facilitation agent is present in an amount of about 1% to about 10% based on the weight of the activated carbon core.

12. A composition comprising:
(a) a plurality of activated carbon particles, the activated carbon particles having an outer surface;
(b) a hydrophobic agent selected from the group consisting of film-forming fluorocarbon polymers, silicones, alkylsilanes, waxes, and mixtures thereof, at least a portion of the hydrophobic agent being disposed on at least a portion of the outer surface of at least a portion of the activated carbon particles; and
(c) a mercury oxidation facilitation agent.

13. The composition of claim 12, wherein the activated carbon particles have a BET surface area of about 500 m²/g or more.

14. The composition of claim 12, wherein the hydrophobic agent is a film-forming fluorocarbon polymer comprising repeating units derived from a monomer selected from the group consisting of fluorinated acrylate monomers, fluorinated acrylamide monomers, fluorinated ethylenic monomers, fluorinated polyols, fluorinated polyisocyanates, and mixtures thereof.

15. The composition of claim 12, wherein the hydrophobic agent is present in an amount of about 0.1% to about 5% based on the weight of the activated carbon particles.

16. The composition of claim 12, wherein at least a portion of the mercury oxidation facilitation agent is disposed on the outer surface of at least a portion of the activated carbon particles.

17. The composition of claim 12, wherein the mercury oxidation facilitation agent is selected from the group consisting of bromide salts, chloride salts, iodide salts, permanganate salts, perchlorate salts, perbromate salts, hypochlorite salts, copper(II) salts, iron(III) salts, cerium (IV) oxide, copper(II) oxide, iron(III) oxide, manganese(IV) oxide, vanadium(V) oxide, elemental halogen species, and mixtures thereof.

18. The composition of claim 12, wherein the mercury oxidation facilitation agent is selected from the group consisting of copper(II) salts.

19. The composition of claim 18, wherein the mercury oxidation facilitation agent is selected from the group consisting of copper(II) chloride, copper(II) bromide, and mixtures thereof.

20. The composition of claim 12, wherein the mercury oxidation facilitation agent is selected from the group consisting of ammonium bromide, magnesium bromide, sodium bromide, elemental halogen species, and mixtures thereof.

21. The composition of claim 12, wherein the mercury oxidation facilitation agent is selected from the group consisting of chlorinated aliphatic compounds, brominated aliphatic compounds, and mixtures thereof.

22. The composition of claim 12, wherein the mercury oxidation facilitation agent is present in an amount of about 1% to about 10% based on the weight of the activated carbon particles.

23. A process for producing treated activated carbon particles, the process comprising the steps of:
(a) providing a plurality of activated carbon particles, the activated carbon particles having an outer surface;
(b) providing a hydrophobic agent selected from the group consisting of film-forming fluorocarbon polymers, silicones, alkylsilanes, waxes, and mixtures thereof;
(c) providing a mercury oxidation facilitation agent;
(d) applying the hydrophobic agent to at least a portion of the outer surface of at least a portion of the activated carbon particles; and
(e) applying the mercury oxidation facilitation agent to at least a portion of the outer surface of at least a portion of the activated carbon particles.

24. A process for producing treated activated carbon particles, the process comprising the steps of:
(a) providing a plurality of activated carbon particles, the activated carbon particles having an outer surface;
(b) providing a hydrophobic agent selected from the group consisting of film-forming fluorocarbon polymers, silicones, alkylsilanes, waxes, and mixtures thereof;
(c) providing a mercury oxidation facilitation agent;
(d) applying the mercury oxidation facilitation agent to at least a portion of the outer surface of at least a portion of the activated carbon particles; and
(e) applying the hydrophobic agent to at least a portion of the outer surface of at least a portion of the activated carbon particles.

25. A process for producing treated activated carbon particles, the process comprising the steps of:
(a) providing a plurality of activated carbon particles, the activated carbon particles having an outer surface;
(b) providing a treatment composition comprising:
(i) a hydrophobic agent selected from the group consisting of film-forming fluorocarbon polymers, silicones, alkylsilanes, waxes, and mixtures thereof; and
(ii) a mercury oxidation facilitation agent; and
(c) applying the treatment composition to at least a portion of the outer surface of at least a portion of the activated carbon particles.
